(19) United States
(12) Patent Application Publication
(10) Pub. No.: US 2009/0277038 A1
(43) Pub. Date: Nov. 12, 2009

(54) DRYING EXPEDIENT

(76) Inventor: Rita Rose Katz, Mill Valley, CA (US)

Correspondence Address: DERGOSITS & NOAH LLP, Suite 1450, Four Embarcadero Center, San Francisco, CA, 94111, US

(21) Appl. No.: 12/115,681

(22) Filed: May 6, 2008

(51) Int. Cl. F26B 5/16

(52) U.S. Cl. 34/353

(57) ABSTRACT

A method of drying an object. The method includes donning a drying expedient, the drying expedient being an absorbent fabric having a top and bottom, width and length, the length defining the distance between the top and bottom. An opening sized and positioned proximate the top is configured within the object to receive the head and neck of a user and a pair of openings are also configured within the drying expedient so that once donned, the drying expedient extends from the neck over the chest terminating below the waist of the user. The method includes grasping a wet object and wrapping the bottom of a drying expedient about it to dry the same.

### TECHNICAL FIELD

The present invention involves a method of drying an object employing a drying expedient as a substitute for a towel. In doing so, an object to be dried can immediately be wrapped about the present invention thus improving upon the drying experience.

### BACKGROUND OF THE INVENTION

Oftentimes, a tub or sink is employed to wash any number of objects, be they human, animal or inanimate. For example, a pet owner will oftentimes take a dog, particularly one which is of modest size, and put it in a sink with an appropriate detergent and wash the dog thoroughly therein. Once the dog has been thoroughly washed, the pet owner will traditionally remove the dog from the sink and grab a towel to begin drying the pet. In doing so, water drips from the pet onto the counter and floor areas proximate the sink and oftentimes, before the pet can be dried, it begins to shake to rid itself of water causing water droplets to be projected throughout the immediate vicinity.

Even infants are oftentimes placed within a sink or tub located within a sink and washed therein. In lifting the infant from the tub, water drips from the infant's body onto the counter, floor and clothing of the parent or caregiver.

It has thus been contemplated that a method could be proposed for improving upon such washing and bathing practices. Particularly, it is an object of the present invention to provide a method of immediately toweling off and drying an object washed in a sink or tub before that object has the opportunity to drip water and cleaning solutions on a user's clothing and surrounding work area.

These and further objects will be more readily apparent when considering the following disclosure and appended claims.

### SUMMARY OF THE INVENTION

A method of drying an object. The method includes donning a drying expedient, the drying expedient being an absorbent fabric having a top and bottom, width and length, the length defining the distance between the top and bottom. An opening sized and positioned proximate the top is configured within the object to receive the head and neck of a user and a pair of openings are also configured within the drying expedient so that once donned, the drying expedient extends from the neck over the chest terminating below the waist of the user. The method includes grasping a wet object and wrapping the bottom of a drying expedient about it to dry the same.

### BRIEF DESCRIPTION OF THE FIGURES

FIG. 1 is a front plan view of a user donning the drying expedient of the present invention.

FIG. 2 is a side view of the individual of FIG. 1 as an individual is washing an object in a tub.

FIG. 3 is the individual of FIG. 1 withdrawing the object from the tub once washed.

FIG. 4 is a side view of the individual of FIG. 1 removing the object from the tub and in doing so, practicing the present invention.

### DETAILED DESCRIPTION OF THE INVENTION

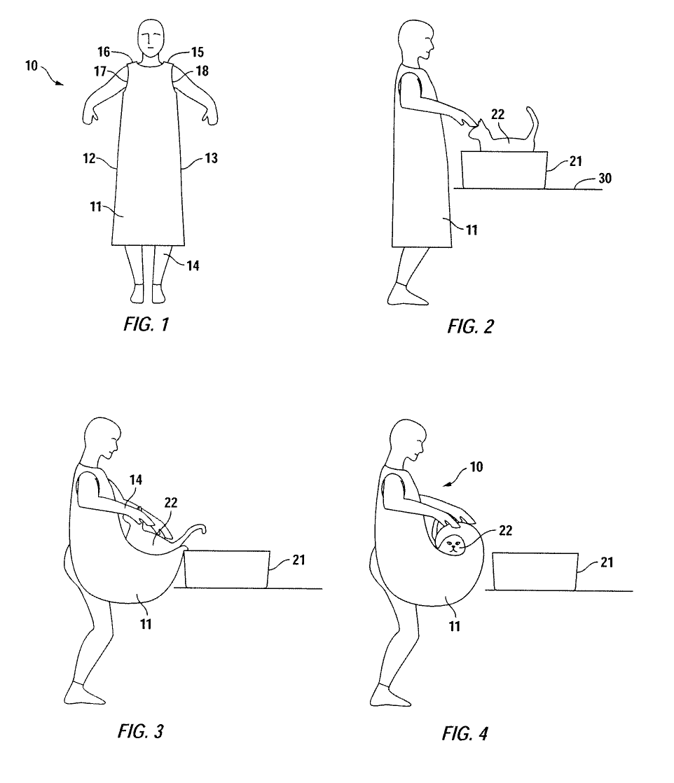

Turning first to FIG. 1, an individual 10 is shown while employing drying expedient 11 of the present invention. The drying expedient comprises an absorbent fabric, such as terry cloth, having a top 15, a bottom 14, and a width between side edges 12 and 13, the distance between top 15 and bottom 14 defining a length thereof. Opening 16 is sized and positioned proximate top 15 to receive the head and neck of user 10. A pair of openings 17 and 18 also proximate said top 15 are configured for receiving the arms of a user so that once donned, the drying expedient extends from the neck region at top 15 terminating below the waist of the user.

Once drying expedient 11 is donned by user 10, object 22 in tub 21 is approached. Typically, tub 21 resides upon counter 30 to enable user 10 to wash object 22 without bending. In this instance, object 22 is a pet.

In turning to FIG. 3, once object 22 is thoroughly washed, it is withdrawn from tub 21 by user 10 and, upon doing so, bottom 14 is immediately extended upwardly to wrap about the body of object 22 as shown in FIG. 4. In doing so, dripping water from object 22 is virtually all captured by absorbent drying expedient 11. Further, there is no need for user 10 to have to reach for a towel or other drying expedients resulting in water dripping from object 22. In addition, in the event that the area surrounding tub 21 is cold, by immediately wrapping drying expedient 11 about object 22, the object is thermally protected from its surrounding; a consideration which becomes particularly important when object 22 is an infant.

In considering the above disclosure, it is readily apparent that the present method represents a significant improvement over drying techniques that have been employed since objects have been washed in tubs or sinks. The objects are, themselves, well protected as there is reduced risk of dropping an object as a user tries to protect himself or herself from water dripping from the object and in reaching for a towel or other drying expedient. The present invention allows the user to use the drying expedient to reduce or completely eliminate water dripping or spilling into his or her surroundings and also clothing is protected as the drying expedient acts as a clothing protectant.

What is claimed is:

1. A method of drying an object comprising donning a drying expedient, said drying expedient comprising an absorbent fabric having a top and bottom, a width and length, said length defining the distance between said top and bottom, an opening sized and positioned proximate said top to receive the head and neck of a user and a pair of openings also proximate said top for receiving the arms of a user so that once donned, said drying expedient extends from the neck over the chest terminating below the waist of said user, grasping said object and wrapping the bottom of said drying expedient about said object to dry the same.

2. The method of claim 1 wherein said drying expedient comprises terry cloth.

3. The method of claim 1 wherein said drying expedient is substantially rectangularly shaped.

4. A method of drying an object positioned in a sink or tub comprising donning a drying expedient, said drying expedient comprising an absorbent fabric having top and bottom, a width and a length, said length defining the distance between said top and bottom, an opening sized and positioned proximate said top to receive the head and neck of a user and a pair of openings also proximate said top for receiving the arms of a user so that once donned, said drying expedient extends from the neck over the chest terminating below the waist of said user, grasping said object from said sink or tub and lifting said object from said sink or tub and wrapping the bottom of said drying expedient about said object as it is lifted from said sink or tub to dry the same.
